(19) United States
(12) Patent Application Publication
(10) Pub. No.: US 2014/0253761 A1
(43) Pub. Date: Sep. 11, 2014

(54) CONTROL DEVICE, CONTROL METHOD, AND IMAGING APPARATUS

(71) Applicant: Sony Corporation, Tokyo (JP)

(72) Inventors: Shunji Okada, Kanagawa (JP); Yuuji Watanabe, Kanagawa (JP); Kentaro Tanaka, Tokyo (JP); Yoshitsugu Nomiyama, Kanagawa (JP); Katsunori Ogawa, Kanagawa (JP); Tomoyuki Mizutani, Kanagawa (JP); Takaya Konishi, Kanagawa (JP)

(73) Assignee: SONY CORPORATION, Tokyo (JP)

(21) Appl. No.: 14/186,210

(22) Filed: Feb. 21, 2014

(30) Foreign Application Priority Data
Mar. 6, 2013 (JP) 2013-043757

(51) Int. Cl. H04N 5/232

(52) U.S. Cl. CPC H04N 5/23296
USPC 348/240.2

(57) ABSTRACT

A control device includes: a detection section configured to detect setting to a predetermined imaging mode; and a control section configured to set a predetermined method of zooming in response to the setting to the imaging mode, and to perform zoom control with a subject distance fixed.

### CROSS REFERENCE TO RELATED APPLICATIONS

This application claims the benefit of Japanese Priority Patent Application JP 2013-043757 filed Mar. 6, 2013, the entire contents of which are incorporated herein by reference.

### BACKGROUND

The present disclosure relates to a control device, a control method, and an imaging apparatus.

Imaging apparatuses that are dedicated to capturing images of very small subjects are familiar (for example, refer to Japanese Unexamined Patent Application Publication No. 2000-184246). In an imaging apparatus disclosed in Japanese Unexamined Patent Application Publication No. 2000-184246, LED (Light Emitting Diode) elements are disposed on the periphery of an objective lens.

### SUMMARY

If it is possible for a user to easily capture images of very small subjects using an imaging apparatus possessed by the user, applications of the imaging apparatus become widespread. In this case, it is necessary for the imaging apparatus to perform control suitable for capturing the images of the very small subjects.

Accordingly, it is desirable to provide a control device, an imaging apparatus, and a control method that are suitable for capturing images of very small subjects.

According to an embodiment of the present disclosure, there is provided a control device including: a detection section configured to detect setting to a predetermined imaging mode; and a control section configured to set a predetermined method of zooming in response to the setting to the imaging mode, and to perform zoom control with a subject distance fixed.

According to another embodiment of the present disclosure, there is provided a method of controlling in a control device, the method including: detecting setting to a predetermined imaging mode; and setting a predetermined method of zooming in response to the setting to the imaging mode, and performing zoom control with a subject distance fixed.

According to another embodiment of the present disclosure, there is provided an imaging apparatus including: an imaging section; a detection section configured to detect setting to a predetermined imaging mode; and a control section configured to set a predetermined method of zooming in response to the setting to the imaging mode, and to perform zoom control with a subject distance fixed.

By an embodiment of the present disclosure, it is possible to perform control suitable for imaging a very small subject.

### BRIEF DESCRIPTION OF THE DRAWINGS

FIG. 1 is a block diagram illustrating an example of a configuration of an imaging apparatus;

FIG. 2A is an explanatory diagram illustrating a normal electronic zoom;

FIG. 2B is an explanatory diagram illustrating a cut-out zoom;

FIG. 3 is a diagram for explaining an example of control corresponding to imaging modes;

FIG. 4 is a diagram for explaining an example of an imaging system;

FIG. 5 is a diagram for explaining an image obtained by an eyepiece and an objective lens of a microscope adapter;

FIG. 6 is a diagram for explaining an image obtained by an eyepiece and an objective lens of a microscope adapter;

FIG. 7 is a diagram for explaining an example of zoom tracking curves;

FIG. 8A is a diagram illustrating an example of an image obtained through a microscope adapter;

FIG. 8B is a diagram illustrating an example of an image obtained by applying zoom processing by a non-deteriorating zoom on the image in FIG. 8A;

FIG. 8C is a diagram illustrating an example of an image obtained by enlarging a part of the image in FIG. 8B;

FIG. 9 is a sequence chart illustrating an example of a processing flow;

FIG. 10 is a sequence chart illustrating an example of a processing flow;

FIG. 11A is an xy chromaticity diagram illustrating a blackbody radiation locus;

FIG. 11B is a diagram obtained by enlarging a part of FIG. 11A;

FIG. 12A is a diagram illustrating an MTF, a spatial frequency, and a pixel pitch at each F number;

FIG. 12B is a diagram illustrating an example of a necessary pixel pitch in order to obtain an MTF response of 0.7 or more at each F number;

FIG. 13 is a diagram illustrating an example of an airy disc;

FIG. 14 is a diagram illustrating an example of the total number of images of various imaging devices, and so on;

FIG. 15 is an explanatory diagram of a limit of a zoom magnification factor of a cut-out zoom; and

FIG. 16 is an explanatory diagram of a zoom control range in an embodiment.

### DETAILED DESCRIPTION OF EMBODIMENTS

In the following, a description will be given of an embodiment of the present disclosure with reference to the drawings. In this regard, the description will be given in the following order.

### 1. An Embodiment

### 2. Variations

In this regard, an embodiment, and so on described in the following is a preferable specific example of the present disclosure. And thus, the contents of the present disclosure are not limited to the embodiment, and so on.

### 1. An Embodiment

Configuration of Imaging Apparatus

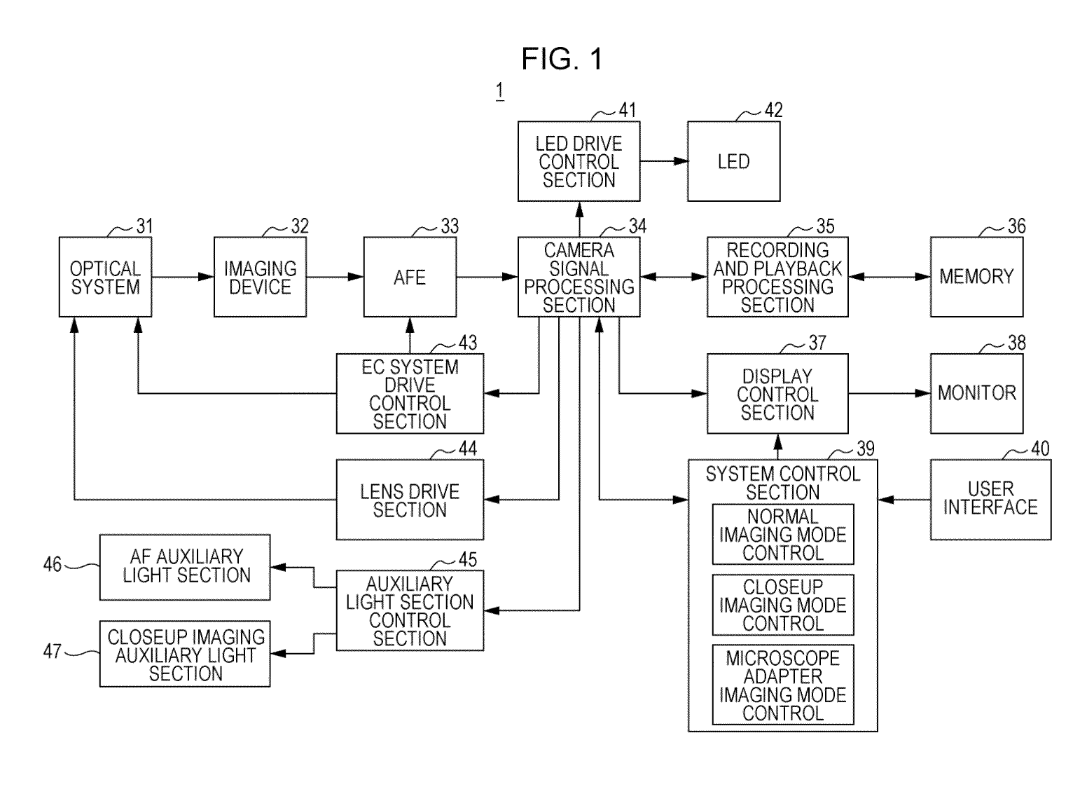

FIG. 1 is a block diagram illustrating an example of a configuration of an imaging apparatus. An imaging apparatus 1 includes, for example an optical system 31, an imaging device (imager) 32, an analog front-end (AFE) 33, a camera signal processing section 34, a recording and playback processing section 35, a memory 36, a display control section 37, a monitor 38, a system control section 39, a user interface (UI) 40, an LED drive control section 41, an LED 42, an EC system drive control section 43, a lens drive control section 44, an auxiliary light section control section 45, an AF (Auto Focus) auxiliary light section 46, and a closeup imaging auxiliary light section 47.

The optical system 31 includes an objective lens, a zoom lens, a focus lens, a camera shake correction lens, an iris mechanism, a mechanical shutter mechanism, and so on. The lens has a bending lens structure, which bends light substantially 90 degrees, for example. By this structure, it is possible to bring the imaging apparatus 1 to a subject or an eyepiece section of a microscope adapter without protruding the objective lens to the outside of the imaging apparatus 1.

The imaging device 32 includes a CCD (Charge Coupled Device) or a CMOS (Complementary Metal Oxide Semiconductor), or the like. The optical system 31 and the imaging device 32 constitute an example of the imaging section. The imaging device 32 outputs analog image data. The analog image data is input into the analog front-end 33.

The analog front-end 33 includes a noise reduction section, a gain control section, an AD (Analog to digital) conversion section, and the like. The analog front-end 33 outputs digital image data. The digital image data is input into the camera signal processing section 34. In this regard, the imaging device 32 and the analog front-end 33 may be formed in one chip.

The camera signal processing section 34 performs various kinds of camera signal processing on input digital image data. The camera signal processing section 34 includes, for example an angle-of-view selection section, a color reproduction correction section which improves a color reproduction characteristic, a noise reduction section which performs noise reduction, a tone reproduction section which adjusts a tone of an image, and a super-resolution processing section. Each of the processing blocks performs camera signal processing on the digital image data. Of course, publicly-noted camera signal processing other than the exemplified processing may be performed. In the case of recording digital image data into the memory 36, and in the case of playing back digital image data recorded in the memory 36, the digital image data is exchanged between the camera signal processing section 34 and the recording and playback processing section 35.

The recording and playback processing section 35 performs processing to compress the digital image data into a predetermined format, such as JPEG (Joint Photographic Experts Group), or the like, and to store the compressed digital image data into the memory 36. Further, the recording and playback processing section 35 performs processing to read image data stored in the memory 36, and to expand the image data.

The memory 36 may be a memory included in the imaging apparatus 1, such as a hard disk or the like, and a portable memory that is detachable from the imaging apparatus 1, such as a semiconductor memory or the like. The memory 36 stores a plurality of pieces of digital image data, attribute information (information, such as shooting date and time, formats, and so on) of the digital image data, music data, and the like.

In the case of playing back the digital image data stored in the memory 36, and in the case of performing live view display, and so on, the digital image data having been subjected to the camera signal processing by the camera signal processing section 34 is supplied to the display control section 37. The display control section 37 functions as a driver that drives the monitor 38. That is to say, the display control section 37 converts the input digital image data into video data in a format corresponding to the monitor 38, and supplies the converted video data to the monitor 38 at proper timing.

The monitor 38 is constituted by an LCD or the like, and displays predetermined video data under the control of the display control section 37. The monitor 38 is formed on an opposite side face to a face on which the objective lens of the imaging apparatus 1 is disposed on the housing of the imaging apparatus 1, for example.

The system control section 39 includes a CPU (Central Processing Unit), a DSP (Digital Signal Processor), a ROM (Read Only Memory) in which programs are stored, a work memory in which data is temporarily stored, and the like, and controls each section of the imaging apparatus 1. The system control section 39 supplies commands to individual sections of the imaging apparatus 1. And the individual sections of the imaging apparatus 1 operate in accordance with the contents of the commands. The commands output from the system control section 39 are supplied, for example through the camera signal processing section 34, or directly to the individual sections.

The system control section 39 has a function of performing control in accordance with an imaging mode. As the imaging mode, it is possible to set the imaging apparatus 1 in a normal imaging mode, a closeup imaging mode, and a microscope adapter imaging mode, for example. The normal imaging mode is a mode for performing normal shooting. The closeup imaging mode is a mode for performing shooting with the imaging apparatus 1 closed up to a subject. The microscope adapter imaging mode is a mode for performing shooting using a microscope adapter. The system control section 39 has a normal imaging mode control function, a closeup imaging mode control function, and a microscope adapter imaging mode control function as functions of controlling these imaging modes, respectively.

The imaging mode is set for the imaging apparatus 1, for example, using the user interface 40. A predetermined imaging mode is set in accordance with operation performed on the user interface 40. An operation signal corresponding to the operation is supplied from the user interface 40 to the system control section 39. The system control section 39 performs control in accordance with the imaging mode indicated by the operation signal. The system control section 39 functions as a detection section and a control section.

The user interface 40 is a generic term for a mechanism for the operation on the imaging apparatus 1. In this regard, if the above-described monitor 38 is constituted as a touch panel, the monitor 38 also functions as the user interface 40. The user interface 40 may be a remote controller that remotely controls the imaging apparatus 1.

Specifically, the user interface 40 is a shutter button or a zoom button. The shutter button is formed as a button capable of two-stage pressing, for example, half-pressing and full-pressing. The zoom button is a button for adjusting a zoom magnification. For example, a user presses a tele (T)-side of the zoom button so as to instruct an increase in the zoom magnification. And the user presses a wide (W)-side of the zoom button so as to instruct a decrease in the zoom magnification.

The LED drive control section 41 is a driver that drives the LED 42. The LED drive control section 41 drives the LED 42 in accordance with a command indicating a light-emission condition that is issued from system control section 39. The LED 42 emits light under the control of the LED drive control section 41.

The LED 42 includes one or a plurality of LED elements. In the case of using a plurality of LED elements, the plurality of LED elements may be connected in series. However, it is necessary to have a large power source voltage for that, and thus the plurality of LED elements are preferably connected in parallel. The LED 42 has the shape of, for example, a bullet, but may have another shape, such as square, cylindrical, or the like.

The LED 42 is constituted as a white LED, for example. A publicly noted method is applied to achieving a white LED. For example, it is possible to achieve a white LED by sealing a blue LEDD with a yellow fluorescent substance. The LED 42 is used for a flash, for example. In place of the LED 42, or together with the LED 42, a xenon flash lamp may be disposed.

The command sent from the system control section 39 is supplied to the EC-system drive control section 43 through the camera signal processing section 34. Each section of the EC system drive control section 43 operates in accordance with the command. The EC system drive control section 43 includes, for example, a gain control section, a shutter speed control section, and an iris control section. The gain control section suitably controls the gain of the gain control section of the analog front-end 33. The shutter speed control section controls a mechanical shutter mechanism included in the optical system 31 at predetermined timing so as to suitably control the shutter speed. The iris control section controls a mechanical iris mechanism included in the optical system 31 so as to suitably control the degrees of the aperture.

The command that is sent from the system control section 39 to the lens drive control section 44 through the camera signal processing section 34. The lens drive control section 44 drives a motor, and the like in accordance with the command, and moves each lens in the optical system 31 to a proper position. For example, the lens drive control section 44 drives the focus lens included in the optical system 31 to a proper position. Thereby, the optical auto focus is achieved. In this regard, the zoom lens and the focus lens in the optical system 31 are controlled to move in coordination.

The auxiliary light section control section 45 performs on/off control of light emission of the auxiliary light section. The auxiliary light section includes, the AF auxiliary light section 46, and the closeup imaging auxiliary light section 47, for example. When it is dark as a result of measuring the brightness of a subject, the light of the AF auxiliary light section 46 is turned on. The subject is lighted by the AF auxiliary light section 46, and AF is executed. In the case where the amount of light in the surroundings is insufficient at the time of macro closeup shooting, the light of the closeup imaging auxiliary light section 47 is turned on.

About Method of Zooming

Next, a description will be given of an example of a method of zooming, which is carried out in the imaging apparatus 1. It is possible for the imaging apparatus 1 to change a focal distance by moving the zoom lens, and the like to perform an optical zoom, which optically enlarges the subject. Further, it is possible for the imaging apparatus 1 to perform a normal electronic zoom and a cut-out zoom in addition to the optical zoom.

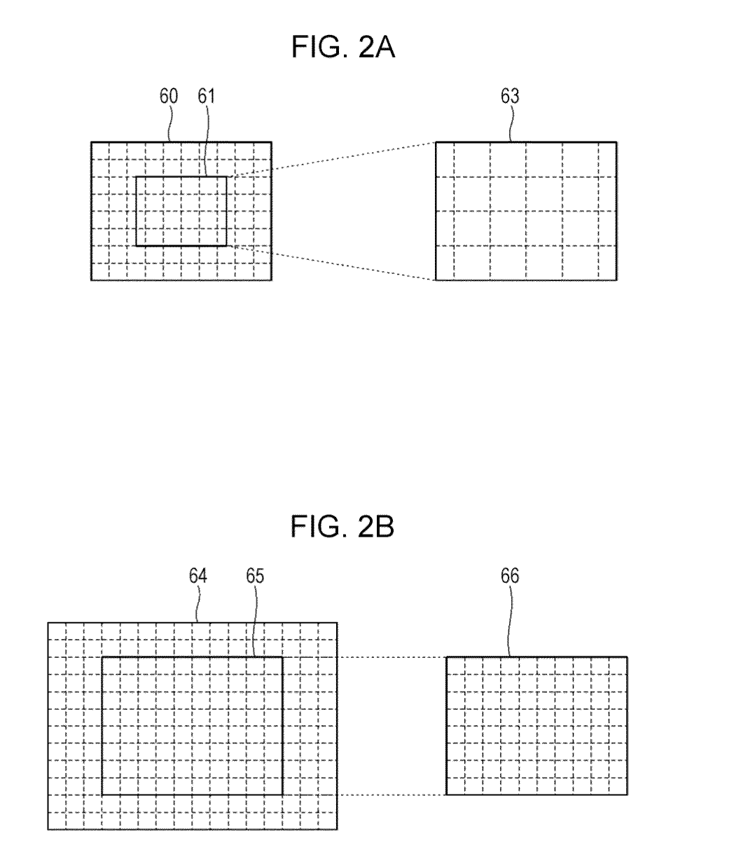

FIG. 2A is an explanatory diagram illustrating a normal electronic zoom. In the normal electronic zoom, a partial area 61 of a maximum range 60 of the imaging device is electronically enlarged. At the time of enlargement, pixels are interpolated, and thus the image quality of the image 63 to be generated is deteriorated.

On the contrary, when shooting is performed with an image size having a smaller number of pixels than the number of pixels of the imaging device, there is a method of cutting out a central part of the imaging device so as to have an effect of zooming (hereinafter, suitably referred to as a cut-out zoom), for example. As illustrated in FIG. 2B, the cut-out zoom uses the difference of angles of views between the maximum range 64 of the imaging device and the cut-out range 65, and thus the image quality of the image 66 to be generated is basically not deteriorated.

For example, in an imaging apparatus provided with an imaging device having the number of pixels of about 5 M (mega: 10 to the sixth power) pixels, when shooting is performed with the pixel size of about 3 M pixels, if calculated from the ratios of the both sides, a zoom ratio of about 1.27 times is obtained. Further, about 3 M is cut out from about 5 M, and thus the image will not be basically deteriorated.

When a zoom function is used, first, the user specifies an image size. By this image size, a zoom magnification of the cut-out zoom function is determined. For example, zooming is performed by the optical zoom function until the zoom magnification exceeds an magnification factor of the optical zoom function by an optical lens. And if the magnification factor of the optical zoom function is exceeded, the cut-out zoom function is further used in combination in order to perform zooming with a high magnification factor.

In zooming by an optical zoom and a cut-out zoom, captured pixels (may be understood as an image quality) will not be substantially deteriorated (non-deteriorated). Accordingly, hereinafter, zooming by the optical zoom and the cut-out zoom is referred to as a non-deteriorating zoom. In this regard, depending on a specification of an imaging apparatus, either one of the optical zoom and the cut-out zoom may be assumed to be a zooming method corresponding to the non-deteriorating zoom.

The zoom magnification of the non-deteriorating zoom is determined by zoom magnification factors of the optical zoom and the cut-out zoom. It is possible to suitably set the details of the zoom magnification of the optical zoom, and the zoom magnification of the cut-out zoom in the non-deteriorating zoom.

In this regard, it is possible to further increase the magnification factor by super-resolution processing in the camera signal processing section 34. For example, it is possible to double the magnification factor by super-resolution processing in which resolution is improved by pixel interpolation, an estimation is made of image quality before deterioration, and the image quality is restored. The super-resolution processing is not limited to the above-described processing, and it is possible to apply publicly noted processing to the super-resolution processing.

In the imaging apparatus 1, any one of the zooming methods is manually or automatically set from a normal electronic zoom (hereinafter, simply referred to as an electronic zoom for short) which causes deterioration of the image quality, an optical zoom, and a non-deteriorating zoom.

Control in Accordance with Imaging Mode

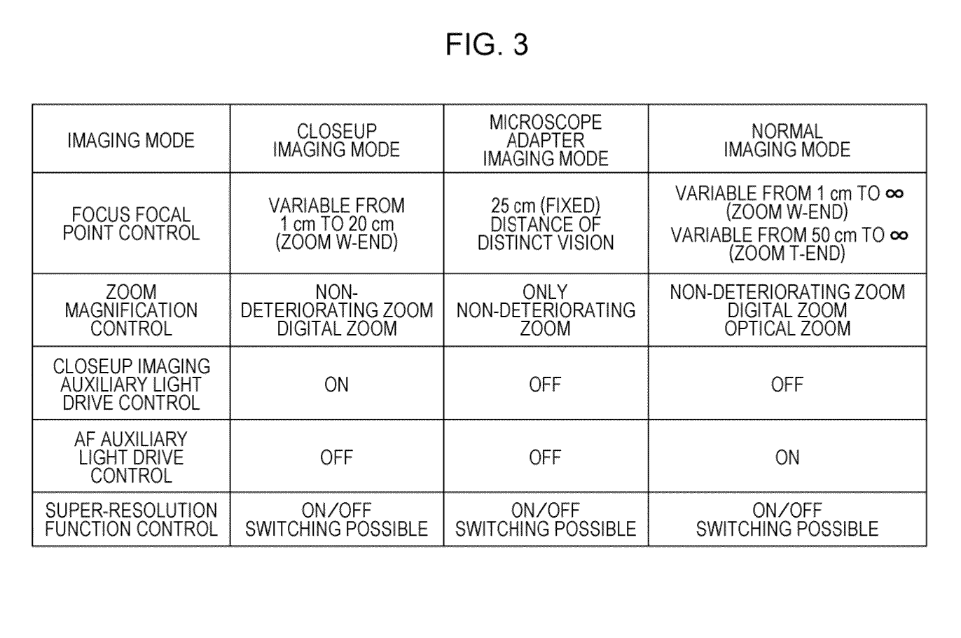

FIG. 3 illustrates an example of control corresponding to imaging modes. A description will be given of a focal distance in focus focal point control. In the closeup imaging mode, the focal distance is variable in a range from 1 cm (centimeter) to 20 cm (zoom wide-end). In the microscope adapter imaging mode, the focal distance is fixed to a predetermined value. The predetermined value is, for example a distance corresponding to a distance of distinct vision, 25 cm. The distance of distinct vision is a distance in which an object is naturally seen by human eyes easily. In the normal imaging mode, the focal distance is variable in a range from 1 cm to infinity (∞) (zoom wide-end) and from 50 cm to infinity (∞) (zoom tele-end).

A description will be given of zoom magnification control. In a closeup imaging mode, it is possible to select a non-deteriorating zoom or an electronic zoom. In the microscope adapter imaging mode, only the non-deteriorating zoom is set. That is to say, in the case where the microscope adapter imaging mode is set, the method of zooming is automatically set to the non-deteriorating zoom. In a normal imaging mode, it is possible to select any one of the electronic zoom, the optical zoom, and the non-deteriorating zoom. In the microscope adapter imaging mode, it is demanded that an observation target be recognized correctly, and thus the electronic zoom which deteriorates an image quality is not used.

A description will be given of control of the closeup imaging auxiliary light section 47. In the closeup imaging mode, in order to supplement a shortage in the amount of light at the time of closeup imaging, the closeup imaging auxiliary light section 47 is turned on. In the microscope adapter imaging mode, the closeup imaging auxiliary light section 47 is turned off. This is because if the light of the closeup imaging auxiliary light section 47 is turned on, the light is reflected in the vicinity of the eyepiece section of the microscope adapter, and the reflected light causes flares and stray light. Accordingly, it is necessary to prevent such flares and stray light. In the normal imaging mode, the closeup imaging auxiliary light section 47 is turned off.

A description will be given of control on the AF auxiliary light section 46. In the closeup imaging mode, the AF auxiliary light section 46 is kept off all the time. In the microscope adapter mode, the AF auxiliary light section 46 is kept off all the time. In the normal imaging mode, if the tone reproduction section of the camera signal processing section 34 determines that the exposure in the shooting angle of view is insufficient, the AF auxiliary light section 46 is turned on.

A description will be given of control of the super-resolution function of the camera signal processing section 34. In the closeup imaging mode and the normal imaging mode, it is possible to turn on and off the super-resolution function. In the microscope adapter imaging mode, only in the case of employing a system configuration allowing use of the non-deteriorating zoom and the super-resolution function in combination, it is possible to turn on and off the super-resolution function. If the super-resolution function is turned on, it is possible to further double the magnification factor of the non-deteriorating zoom, for example.

Configuration of Imaging System Using Microscope Adapter

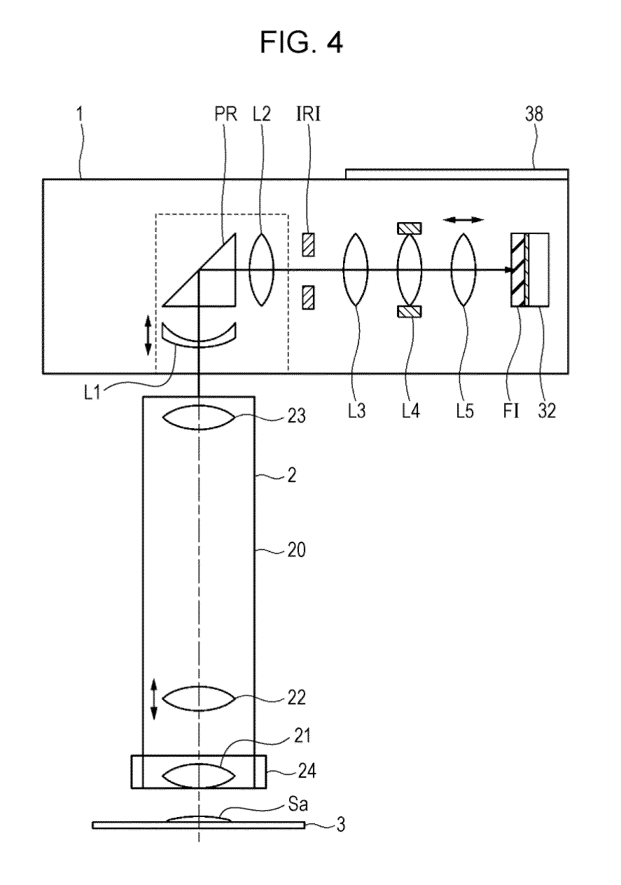

FIG. 4 illustrates an example of a configuration of an imaging system using a microscope adapter. The imaging system includes an imaging apparatus 1, a self-standing microscope adapter 2, and a sample stage 3, for example. A sample Sa is mounted on the sample stage 3. The microscope adapter 2 and the sample stage 3 may be integrally configured. At least one of the microscope adapter 2 and the sample stage 3 is allowed to move in the vertical direction (the up and down direction).

Although illustration is omitted in FIG. 4, a transparent plate-shaped body (for example, an acrylic plate) is disposed between the imaging apparatus 1 and the microscope adapter 2. The user places the imaging apparatus 1 on the plate-shaped body such that the position of the objective lens of the imaging apparatus 1 and the position of the eyepiece section (the place in the vicinity of the eyepiece 23 described later) of the microscope adapter 2 are opposed to each other. It is not necessary to dispose a mechanism for connecting the microscope adapter 2 on the imaging apparatus 1, and thus it is possible to use an existing imaging apparatus. Of course, the present disclosure does not exclude a configuration of mechanically connecting the imaging apparatus 1 and the microscope adapter 2.

In FIG. 4, the optical system 31, the imaging device 32, and the monitor 38 of the imaging apparatus 1 are illustrated. The optical system 31 includes, for example a zoom lens L1, a prism PR that bends a light path, a fixed convex lens L2, an iris IRI, a fixed convex lens L3, a lens L4 for performing optical camera shake correction, and a focus lens L5.

The zoom lens L1 and the focus lens L5 are movable in the direction parallel to a light path OP. The lens L4 is movable in the vertical direction with respect to the light path OP. In this regard, the individual lenses may constitute a lens group including a plurality of lenses. Further, it is possible to suitably change the disposition of the individual lenses.

An optical filter FI and the imaging device 32 are disposed at the subsequent stage of the focus lens L5. An image of the sample Sa that is obtained through the microscope adapter 2 and the imaging apparatus 1 is displayed on the monitor 38 of the imaging apparatus 1.

The microscope adapter 2 includes a cylindrical lens barrel 20, for example. An objective lens 21 is disposed at one end of the lens barrel 20, and an eyepiece 23 is disposed at the other end of the lens barrel 20. Further, a focus adjusting lens 22 is disposed in the lens barrel 20. The position of the lens 22 is movable. The magnification of the objective lens 21 is 40 times, for example. The magnification of the eyepiece 23 is 10 times, for example. The total magnification of the microscope adapter 2 becomes 400 times. Further, the final magnification is produced by multiplying the magnification by the zoom magnification of the non-deteriorating zoom of the imaging apparatus 1.

For example, a ring-shaped LED 24 is disposed in the surroundings of the objective lens 21. The LED 24 is a white LED, for example. Although illustration is omitted in FIG. 4, a switch for turning on/off the light emission of the LED 24 is disposed at a suitable position on the circumferential surface of the lens barrel 20. When performing the microscope adapter imaging, the LED 24 is turned on, and the light of the LED 24 illuminates the vicinity of the sample Sa.

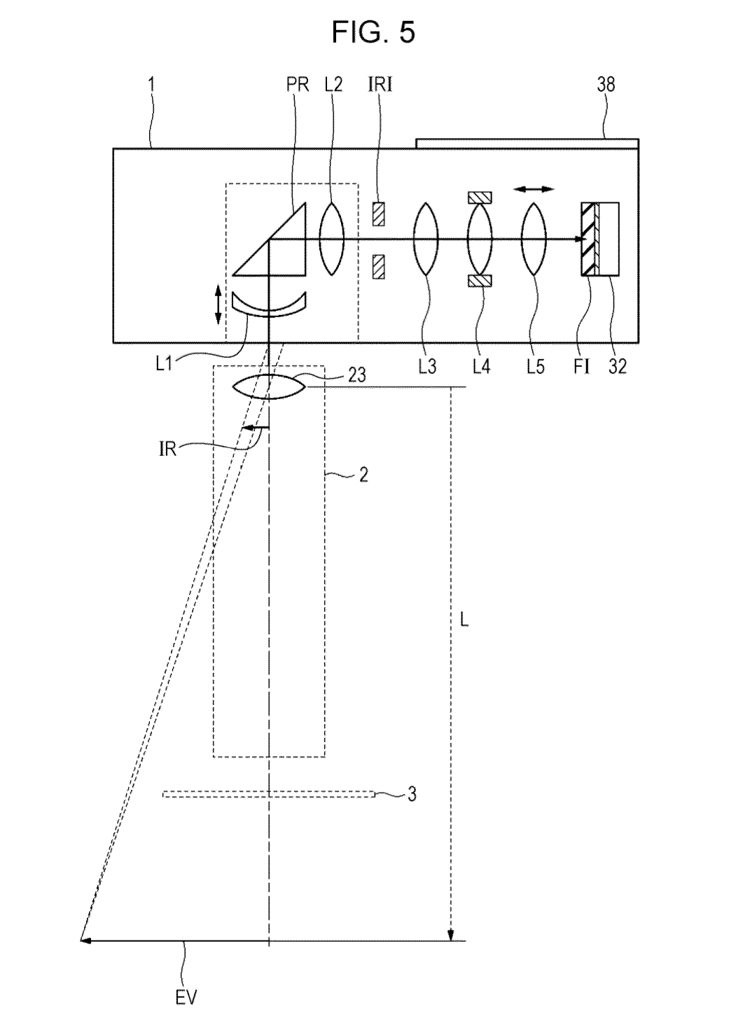

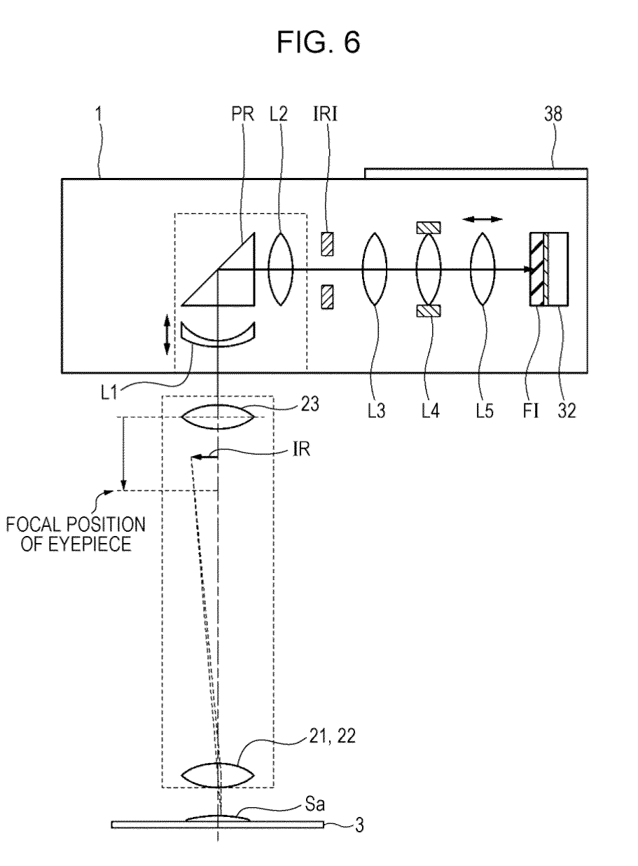

FIG. 5 and FIG. 6 are diagrams for explaining an image formed by the objective lens 21 and the eyepiece 23. In this regard, the objective lens 21 and the focus adjusting lens 22 are illustrated as one lens in FIG. 6.

The sample Sa to be an observation target is placed at a bit of outside the focal point of the objective lens 21. The objective lens 21 forms an inverted real image IR. As illustrated in FIG. 6, the inverted real image IR is formed a bit of inside the focal point of the eyepiece 23. Next, the eyepiece 23 enlarges the inverted real image IR to form an erected virtual image EV. The erected virtual image EV is formed at a position with a distance L away from the eyepiece section of the microscope adapter 2. In a microscope, usually, an erected virtual image EV is designed to be formed at the distance of distinct vision. Accordingly, the erected virtual image EV is formed at a position of L=0.25 (m).

The distance between the objective lens of the imaging apparatus 1 and the vicinity of the eyepiece section of the microscope adapter 2 is small. Thus, if this distance is disregarded, it is thought that the distance from the objective lens of the imaging apparatus 1 to the subject (the erected virtual image EV) is a distance of distinct vision of cm. In the microscope adapter imaging mode, the zoom control ought to be performed on the condition that the subject distance is fixed to 25 cm in order to fix the focal point. The zoom control includes, for example, control for moving the zoom lens, and the like to a proper position, and control for suitably set the magnification factor of the non-deteriorating zoom. In the following, a description will be given of details of the zoom control in the microscope adapter imaging mode.

An Example of Zoom Control

As described above, the non-deteriorating zoom uses the optical zoom, and the cut-out zoom. A description will be given of the optical zoom control in the case of fixing the subject distance (L) at 25 cm.

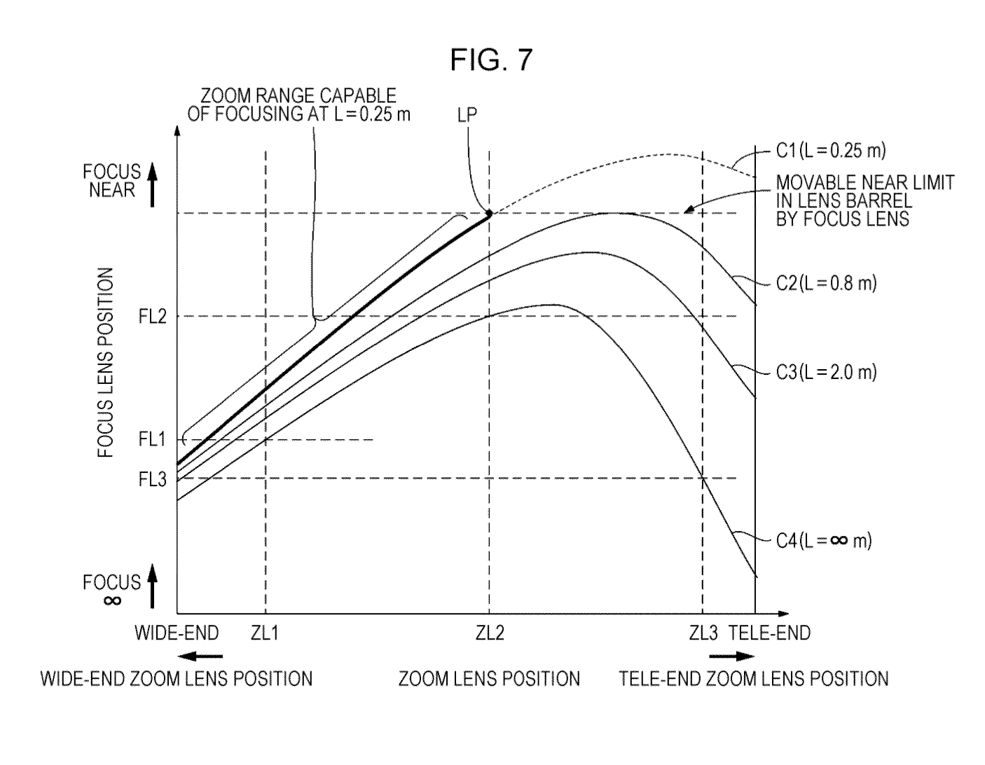

When the zoom lens L1 and the focus lens L5 are moved while the image forming position is kept at constant, the positional relationship between the zoom lens L1 and the focus lens L5 is represented by curves C1, C2, C3 and C4 in FIG. 7. The horizontal axis in FIG. 7 represents a change in the position of the zoom lens L1. A position ZL1 on the horizontal axis corresponds to the position of the wide-end of the zoom lens L1. A position ZL3 on the horizontal axis corresponds to the position of the tele-end of the zoom lens L1.

The curve represented by C1, and the like are called zoom tracking curves. In order to perform zooming in a state of being in focus (in focus), the focus lens L5 ought to be moved along the zoom tracking curves when the zoom lens L1 is moved.

The curves C1, C2, C3 and C4 represent the zoom tracking curves in the case where the subject distance is 0.25 m, 0.8 m, 2.0 m, and infinity, respectively. The zoom tracking curves are determined at design time in association with the characteristics of the components of an optical system, such as a zoom lens, a focus lens, and the like.

A zoom tracking curve changes in accordance with a subject distance, and thus in the imaging apparatus 1, the zoom tracking curves of the typical distances are stored in the memory. A zoom tracking curve of a distance other than those is obtained on the basis of the zoom tracking curves of the typical distances.

As described above, L=25 cm (0.25 m) in the microscope imaging mode, and thus the zoom lens L1, and so on, are moved on the basis of the curve C1. The zoom lens L1 is moved from the wide-end position ZL1 to the tele-end position ZL3. However, there is a limit of position to which the focus lens L5 is capable of moving in the imaging apparatus 1, and thus there is a limit of position to which the zoom lens L1 is allowed to move. In FIG. 7, the limit position to which the zoom lens L1 is allowed to move is denoted by ZL2.

That is to say, the zoom lens L1 is moved to the position corresponding to ZL2, and the focus lens L5 is moved to the near-end limit position to which the focus lens L5 is allowed to move in the lens barrel. The zoom lens L1 and the focus lens L5 are moved to a position corresponding to LP in the curve C1, the zoom magnification at this time is the upper limit of the zoom magnification of the optical zoom. The upper limit of the zoom magnification of the optical zoom is from about two times to three times, for example. If the zoom magnification of the optical zoom has reached the upper limit, the zoom magnification is further increased in combination with the cut-out zoom.

In the cut-out zoom, the file size (the number of pixels) of the image to be recorded is set such that the zoom magnification becomes the maximum. For example, the number of pixels of the imaging device 32 is assumed to be 16 M. The file size of the recorded image is assumed to be set to any one of 16 M, 8 M, 5 M, 3 M, 1 M, and VGA (640 pixels in the horizontal direction (H)×480 pixels in the vertical direction (V)), for example. If the file size of the recorded image is set to 16 M, the cut-out zoom is not operated.

In order to maximize the zoom magnification of the cut-out zoom, the file size of the image to be recorded is set to a minimum (in this example, the VGA size) in the microscope adapter imaging mode. If the file size of the image to be recorded is VGA, a zoom magnification of about 7.2 times (4608/640) is obtained.

However, in the case where the subject distance is 0.25 m, if the cut-out zoom is performed with a zoom magnification of 7.2 times, the image might be out of focus. Thus, in the microscope adapter imaging mode, control is performed in order to limit the zoom magnification in a suitable range.

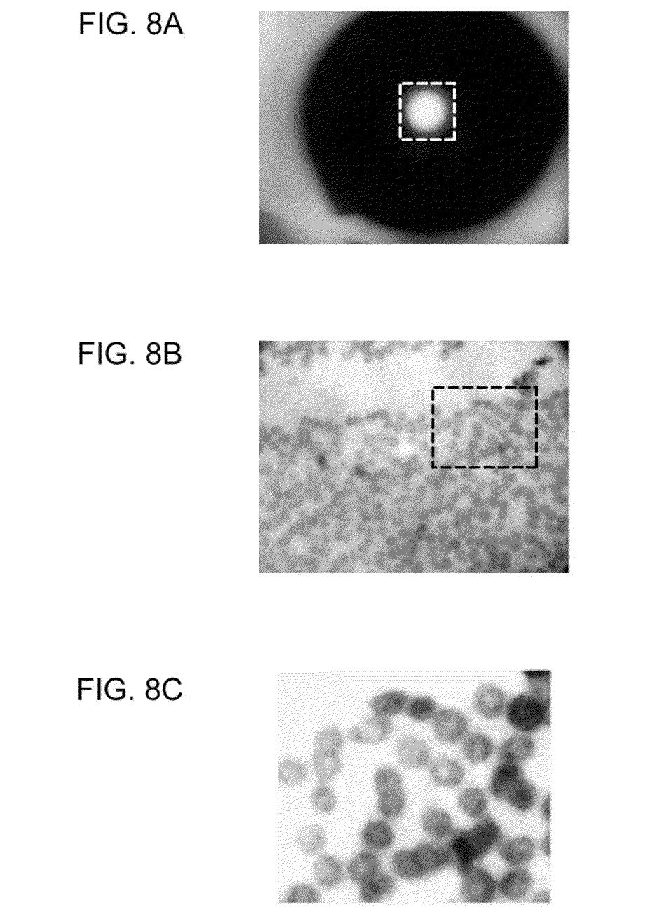

For example, a lower limit and an upper limit of the zoom magnification are set. The lower limit of the zoom magnification is set as follows, for example. FIG. 8A illustrates an example of an image to be displayed on the monitor 38 of the imaging apparatus 1 in the microscope adapter imaging mode. The image in FIG. 8A is an image displayed (through image) on the monitor 38 when an acrylic plate is placed on the imaging apparatus 1, and a non-deteriorating zoom is not applied.

The black place of the image in FIG. 8A, which is substantially circular, is a place corresponding to the vicinity of the eyepiece section of the microscope adapter 2 and the inside of the lens barrel 20. Further, the vicinity of the center of the image (the place enclosed by a dotted line) is a place corresponding to the vicinity of the end section (the side of the objective lens 21) of the microscope adapter 2. The LED 24 formed in the surroundings of the objective lens 21 is lighted, and thus the vicinity of the center of the image is reflected in white. The place enclosed by the dotted line is enlarged by the non-deteriorating zoom.

In the microscope adapter imaging, non- deteriorating zoom is performed such that the magnification factor that causes the periphery of an image in the vicinity of the end part of the microscope adapter 2 to be excluded from the shooting angle of view is set to a lower limit, and the zoom magnification not less than the lower limit is obtained. The lower limit of the zoom magnification is suitably determined in accordance with the size of the lens barrel 20 of the microscope adapter 2, and so on. The upper limit of the zoom magnification of the non-deteriorating zoom is set in the range that allows keeping the distance of distinct vision of 25 cm by zoom operation, that is to say, in the range that brings into focus at the distance of distinct vision of 25 cm.

FIG. 8B illustrates an example of an image obtained by applying non-deteriorating zoom on the image in FIG. 8A. FIG. 8B illustrates an image of human red blood cells, for example. FIG. 8C illustrates an example of an image displayed, for example on a monitor of a personal computer, by enlarging a part enclosed by a dotted line in the image in FIG. 8B.

Example of a Processing Flow

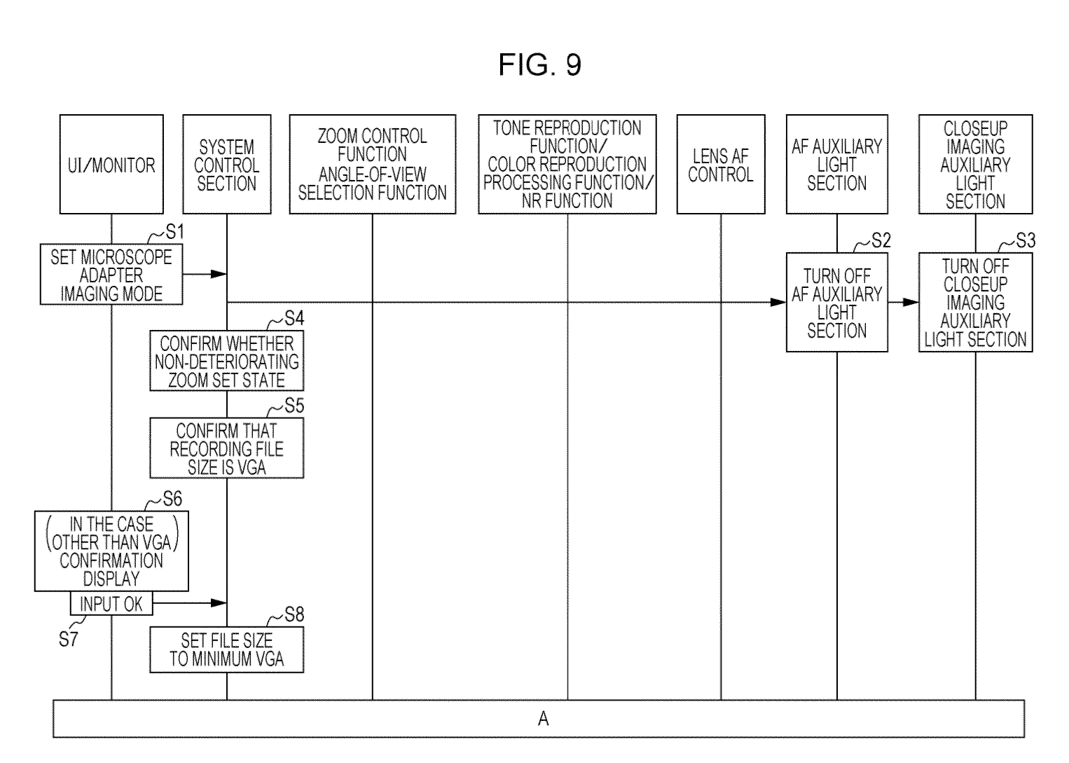

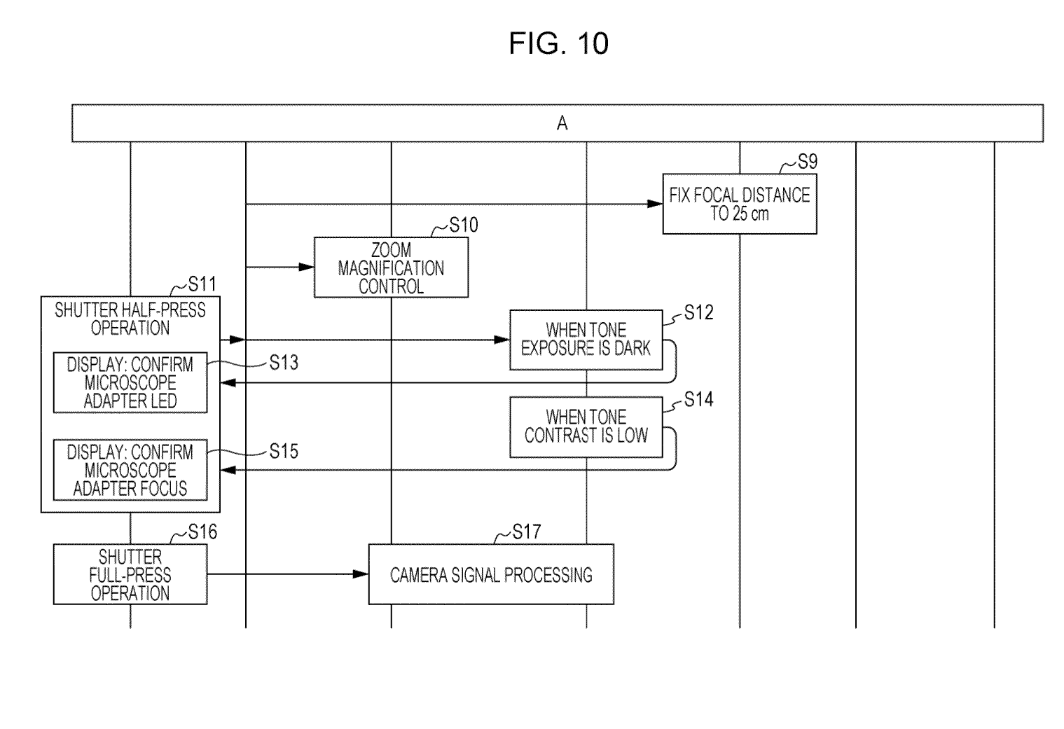

FIG. 9 and FIG. 10 are sequence charts illustrating an example of a processing flow of control in the microscope imaging mode. In this regard, a notation A in FIG. 9 and FIG. 10 indicates a continuation of the processing, and does not indicate specific processing.

For example, a user operates the user interface 40 to set the microscope adapter imaging mode (step S1). An operation signal indicating the setting of the microscope adapter imaging mode is supplied from the user interface 40 to the system control section 39.

The system control section 39 performs control of the microscope adapter imaging mode in response to the operation signal. The system control section 39 transmits a command for turning off the AF auxiliary light section 46 and the closeup imaging auxiliary light section 47 to the auxiliary light section control section 45. The auxiliary light section control section 45 turns off the AF auxiliary light section 46 and the closeup imaging auxiliary light section 47 in response to the command from the system control section 39, and prohibits lighting of these sections (step S2 and step S3).

And the system control section 39 autonomously confirms whether a method of zooming set to itself is a non-deteriorating zoom or not (step S4). Here, if the method of zooming is another method (an electronic zoom, and so on), the system control section 39 compulsorily sets the method of zooming to the non-deteriorating zoom.

Next, the system control section 39 confirms the size of the image file to be written into the memory 36 by the recording and playback processing section 35. The size of the image file is set to the minimum size such that the zoom magnification of the non-deteriorating zoom becomes the maximum (step S5). For example, the image file is set to the VGA size. The system control section 39 sets the file size of the image to be processed to VGA.

Here, if the image file size set until now is not VGA, the user may confirm a change of the image file size. For example, a message stating “Is it OK to change the image size to VGA?” is displayed on the monitor 38. Further, an OK button is displayed in the vicinity of the display (step S6). In response to this display, the user touches the OK button (step S7). In response to this input operation, the system control section 39 sets the file size of the image to be processed to VGA (step S8).

In this regard, the processing in step S6 and step S7 may not be performed. For example, if the file size of the image to be recorded is not a minimum, control to compulsorily set the image file size to a minimum file size may be performed.

The system control section 39 controls the lens drive control section 44. By this control, the focal distance of the lens AF control is fixed to 25 cm, which is a distance of distinct vision with the naked eye (step S9). This is a distance corresponding to the specification to be a basis of the optical design of the eyepiece section of the microscope adapter 2.

Further, the system control section 39 drives the zoom lens L1, and so on. The optical zoom is performed in accordance with the control of the moving of the zoom lens L1, and so on. Further, a non-deteriorating zoom is performed by carrying out a cut-out zoom (step S10). By the non-deteriorating zoom, a subject is enlarged to the extent of the upper limit of the zoom magnification (for example, 5.2 times) in the range of being in focus at the subject distance 25 cm.

Next, the shutter button of the user interface 40 is half pressed (step S11). In response to the half-press operation of the shutter button, the system control section 39 causes the tone reproduction section of the camera signal processing section 34 to determine tone exposure. If determined that the exposure is insufficient as a result of this determination (step S12), the system control section 39 controls the display control section 37 to display a warning.

If the exposure is insufficient, the amount of light in the vicinity of the sample stage 3 is insufficient, that is to say, there is a possibility that the LED 24 is off. Accordingly, a message stating “Please confirm the microscope adapter LED” is displayed on the monitor 38, for example (step S13). In response to the display, the user ought to turn on the LED 24 of the microscope adapter 2.

Further, the tone reproduction section may determine the tone contrast. As a result of the determination, if the tone contrast is low (step S14), a warning may be displayed. If the tone contrast is low, for example, a message stating “Confirm focus of the microscope adapter” is displayed on the monitor 38 (step S15). In response to the display, the user adjusts the distance between the microscope adapter 2 and the sample stage 3 to adjust the focal point.

And the shutter button is full-pressed (step S16). Shooting is carried out in response to the full-press of the shutter button. The image obtained by the shooting is subjected to camera signal processing by the camera signal processing section 34 (step S17). The camera signal processing is performed on a VGA-size image obtained by a non-deteriorating zoom. The image data having been subjected to the camera signal processing is suitably recorded into the memory 36.

### EXAMPLE

A description will be given of an example. In this regard, the contents of the present disclosure is not limited to the example described in the following.

As described above, an imaging apparatus is used to perform microscope imaging on a minute object. For example, a microscope imaging apparatus, in which an imaging apparatus is attached to a microscope, is used. However, in the microscope imaging apparatus, it is necessary to precisely move the imaging apparatus up and down by a few μm (microns), and thus the apparatus itself becomes expensive.

In recent years, imaging devices of small-sized digital cameras for general use have been remarkably improved to have high resolutions to the extent of coming close to optical resolution limits of lenses. If it becomes possible to easily capture a light image seen by a microscope adapter with an eyepiece using the small-sized digital camera, and to perform suitable control on a microscope imaging apparatus on a translucent minute creature, and the like, applications of the digital camera expands widely. For example, it becomes possible to capture an image of a translucent minute creature, and so on by performing only imaging operation on a small-sized digital camera. This will contribute to improvement of children's motivations for learning in bioscience educational fields.

Accordingly, the example provides an imaging apparatus capable of capturing a clear subject image just as observed. To date, if a light image of a sample that is allowed to be observed from an exit pupil of an eyepiece using a small-sized microscope adapter is captured in a state attached with an eyepiece, only a blurred image has been allowed to be captured. Using an imaging apparatus according to the example, any user is allowed to easily capture a minute creature, and so on without using a large-sized expensive microscope imaging apparatus that necessitates high-precision adjustment.

In this regard, an MTF (Modulation Transfer Function) in the example is a modulation transfer function, and means an optical lens response function for a subject having optical sinusoidal wave tone contrast, for example. Also, in the non-deteriorating zoom according to the example, an MTF response of an optical lens is maintained with reference to a predetermined contrast up to a predetermined pixel pitch. For capturing a normal subject having an opacity of 100%, a pixel pitch of MTF response 0.1 or more becomes the resolution limit.

About Microscope Adapter LED in the Example

A description will be given of the LED 24 of the microscope adapter 2 according to the example. In order to ensure contrast at the time of capturing an image of a minute creature, or the like which is translucent and has little contrast, the LED 24 illustrates side lighting illumination in epi-illumination. It is assumed that the imaging apparatus 1 according to the example is not an expensive imaging apparatus, but an imaging apparatus in a popular price range. In a focus method for such an imaging apparatus, a contrast AF method, which is allowed to be configured at a lower price than a phase difference AF, is generally used. Accordingly, it becomes necessary to have contrast by the LED 24 as much as possible.

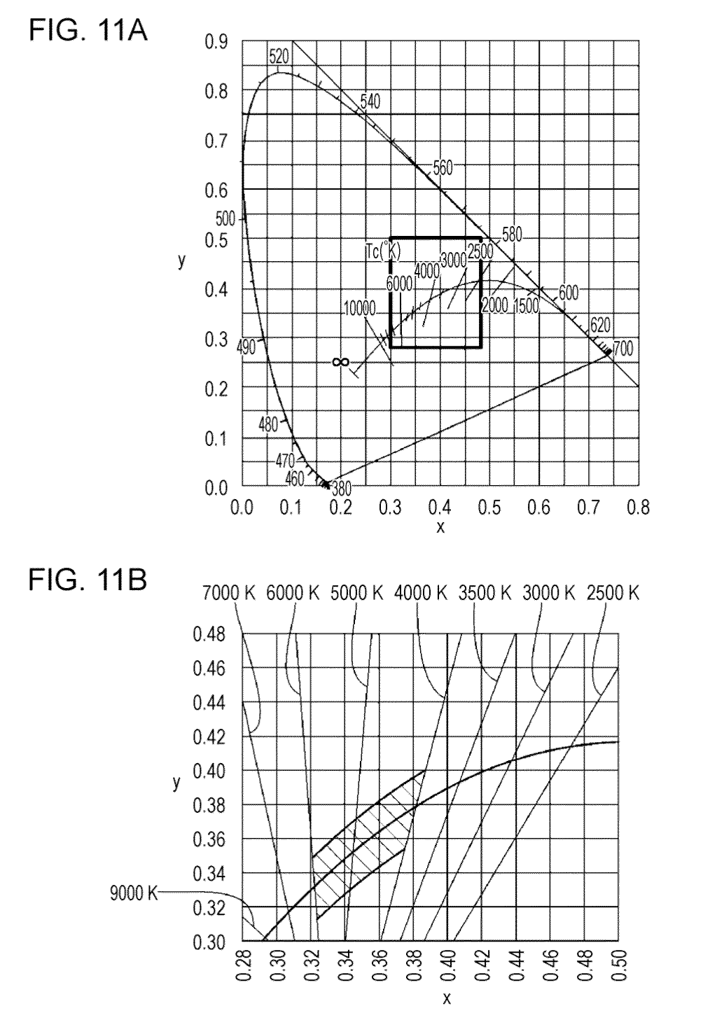

FIG. 11A illustrates a relationship between color temperature and blackbody radiation locus. The color temperature is defined as a temperature of a blackbody that emits the same color as that of light from a light source using a relationship between color of a burning blackbody and a temperature, for example, and K (Kelvin) is used as a unit. The locus of temperature and the color (black body locus) expressed in an xy chromaticity diagram is illustrated in FIG. 11A. A diagram produced by enlarging a part of FIG. 11A is illustrated in FIG. 11B.

The range of a color temperature allowed to be pulled in by the camera signal processing section 34 of the imaging apparatus 1 is about 7000 K. In consideration of this point, it is desirable to provide the microscope adapter 2 with an LED 24 having a color temperature 5000 K at center (the color temperature range is a range from 4000 K to 6000 K, which is a shaded portion in FIG. 11B).

About Selection of Optical Zoom in the Example

For an optical zoom method of a optical lens, proposals have been made of an extension zoom method and an inner zoom method. In the extension zoom method, an objective lens moves forward at the time of an optical zoom, and thus the distance from the imaging surface of the imaging device 32 to the eyepiece section of the microscope adapter 2 becomes long. A circular holding section holding an exit pupil of an eyepiece is positioned ahead of the extended distance as a circular aperture in an angle of view of a shot image, and thus a so-called small aperture blur which deteriorates the diffraction limit resolution of the optical lens of the optical system 31 occurs. Accordingly, a light image exposed on the imaging surface of the imaging device 32 is blurred significantly.

On the other hand, in the inner zoom method, the distance between the imaging surface of the imaging device 32 and the lens exit pupil of the eyepiece section of the microscope adapter 2 remains constant, and does not change by an optical zoom objective lens. Accordingly, when a light image in the lens exit pupil of the eyepiece section is enlarged by zoom-in, it is possible to exclude the circular holding section in the periphery of the eyepiece section out of the angle of view. As described above, in the optical zoom method of the optical lens according to the example, the inner zoom method is employed.

About Imaging Section in the Example

For example, a subject of a living body that is as thin as a few microns becomes translucent, and the contrast deteriorates. The image of such a subject is captured by an imaging apparatus of a contrast AF method, for example, and thus in the example, the imaging section is set to have an MTF response of an optical lens of 0.7 or more, for example.

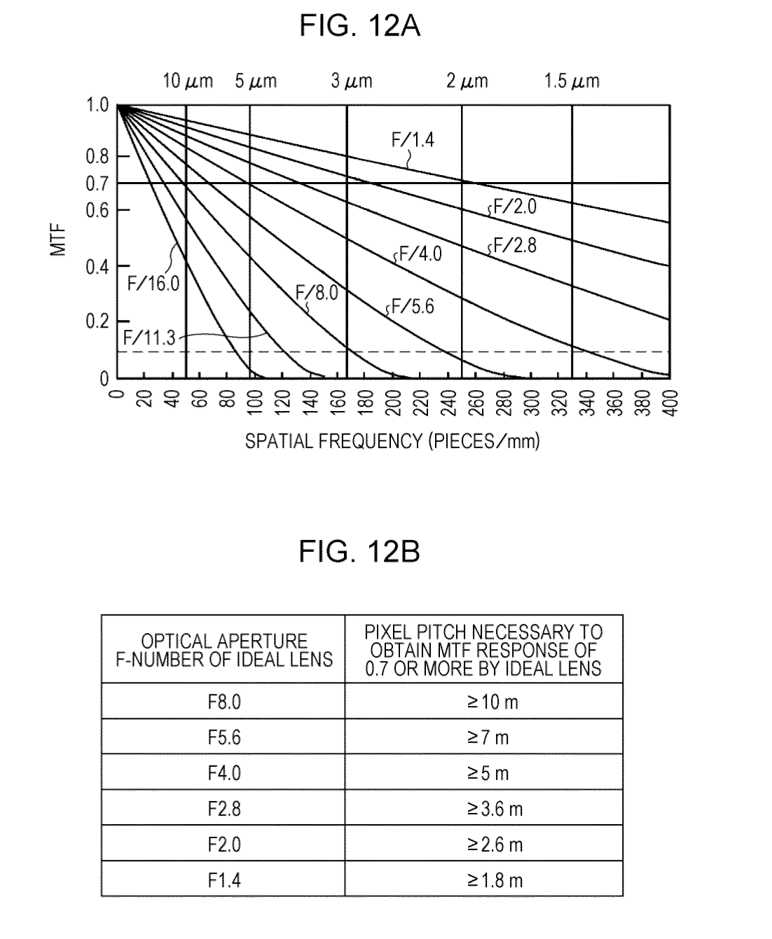

FIG. 12A is a graph illustrating an example of a pixel pitch of the imaging device 32 from which MTF response of the optical lens of 0.7 or more is obtained. The vertical axis of the graph illustrated in FIG. 12A represents MTF response (value from 0 to 1). In the example, the pixel pitch of the imaging device 32, and so on are set so that the MTF response of 0.7 or more is obtained. The horizontal axis of the graph illustrated in FIG. 12A represents pixel pitch limit, and spatial frequency (pieces/mm) of MTF of an imaging device corresponding to MTF of a ideal lens having no aberration. The pixel pitch is calculated by the reciprocal of two times the number of line pairs on the assumption that a pair of white and black lines is one piece. For example, assuming that the pixel pitch is D, and the spatial frequency is U, the pixel pitch D is defined by the following expression (1).

pixel pitch D=1/(2*spatial frequency U) (1)

In FIG. 12A, graduations of 10 microns, 5 microns, microns, 2 microns, and 1.5 microns are given as pixel pitches. Further, in FIG. 12A, the characteristics of the MTF and the pixel pitch of the imaging device 32 are indicated at individual values of the F-numbers of an ideal lens. The international F-number sequence is used for individual F-numbers of a lens, which become the characteristic parameters.

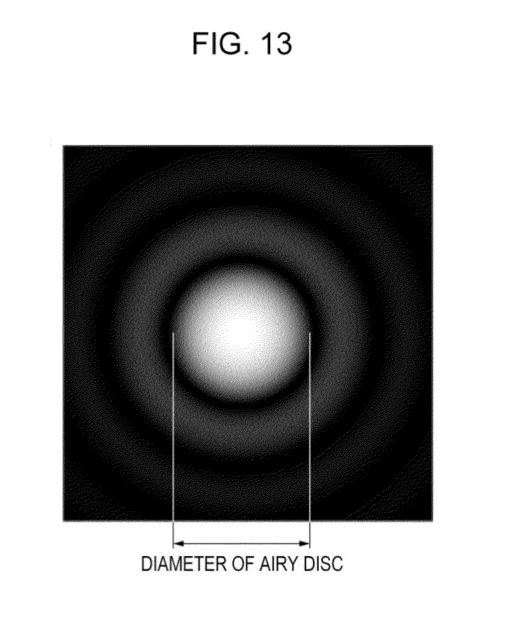

FIG. 12B illustrates minimum limits of the pixel pitches of the imaging device 32 corresponding to MTF responses, which are obtained on the basis of FIG. 12A, respectively. The values of the pixel pitches illustrated in FIG. 12B are diffraction limits at individual F-numbers in the case of shooting by an ideal lens having no distortion, to put it another way, values equal to the diameters of airy discs. FIG. 13 illustrates an example of a diameter of an airy disc.

If it is assumed that the optical lens of the imaging apparatus 1 according to the example has F2.8 at the W-end, the F-number becomes lower than the optical zoom (the zoom magnification is 2.5 times, for example), and thus a so-called F drop occurs. By the optical zoom, the F-number decreases to F4.0, for example. Here, in order to ensure an MTF response of 0.7 or more at F4.0, as illustrated in FIG. 12B, one side of 5 microns or more becomes necessary for one unit of the pixel pitch of the imaging device 32. In the imaging device 32, in an imaging pixel unit smaller than 5 microns for each one side, it is difficult to obtain an MTF response of 0.7 or more.

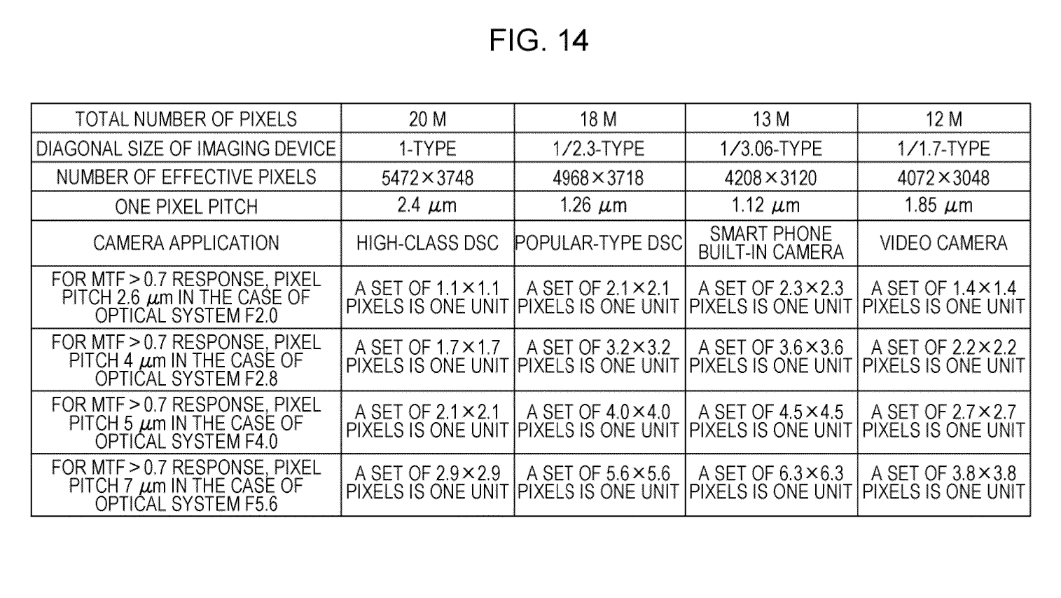

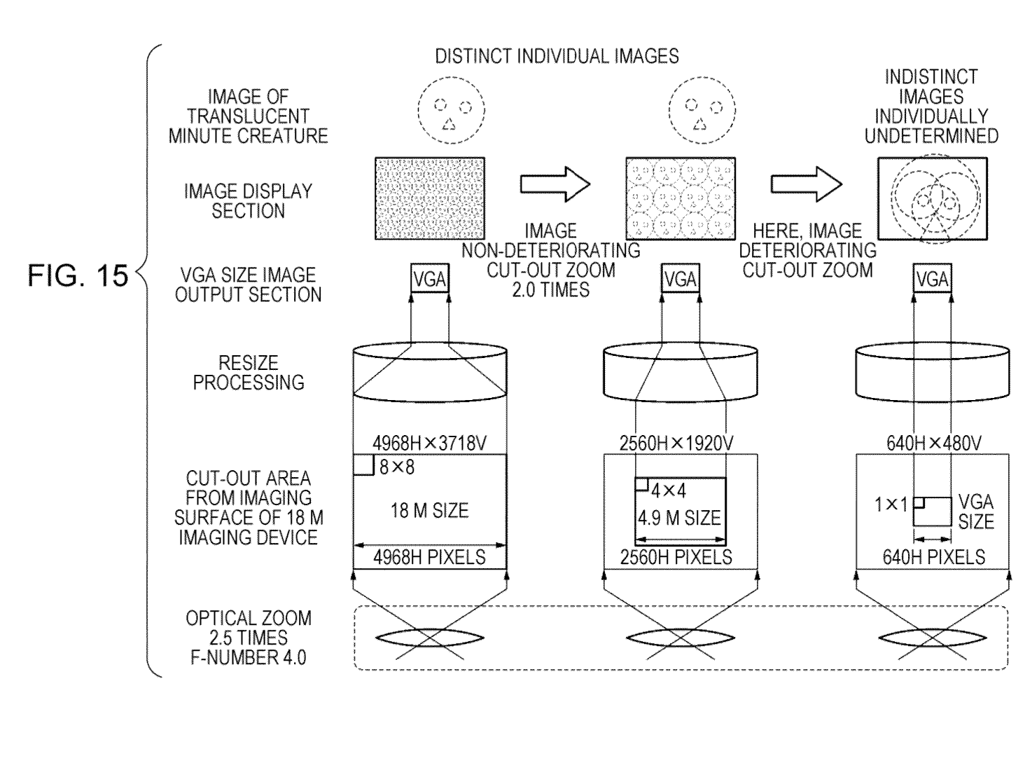

FIG. 14 illustrates a plurality of patterns of the total number of pixels of an imaging device, and an example of the diagonal size of an imaging device corresponding to each of the total number of pixels, the number of effective pixels, one pixel pitch, and a typical application of the imaging apparatus, and so on. Also, FIG. 14 indicates, the number of pixel sets on the actual imaging surface that is equivalent to one unit of pixel that is not deteriorated on the imaging surface for each optical system F-number. A specific description will be given of this point with reference to FIG. 15. In this regard, the reason why a pixel set unit is not a positive integer, but a positive real number is that thinning interpolation processing (resize processing) is considered to be performed while keeping the resolution at exposure time in the image processing at the time of cutting out pixels from the imaging surface including a large number of high-precision pixels exceeding 10 mega as a VGA output, and performing an electronic zoom.

For example, it is assumed that the imaging device 32 of the imaging apparatus 1 is 1/2.33 type, and the total number of pixels is 18 M. In this case, as illustrated in FIG. 14, one pixel pitch of the imaging device 32 is 1.26 microns. As described above, the camera lens of the optical system 31 is the optical zoom 2.5 times, and the F-number decreases to F4.0. That is to say, in the example, in the case of using a lens MTF response of 0.7 or more in order to capture the image of a translucent subject, it is difficult to achieve by employing one pixel unit of the 18-mega imaging device having one pixel size 1.27 microns, and it is necessary to handle at least a pixel set 4.0 H×4.0 V as one pixel, and perform the camera signal processing, and so on.

FIG. 15 is an explanatory diagram of control of a cut-out zoom range in consideration of a pixel pitch limit at which an image formed on an imaging device surface is blurred because of a F-drop by a lens MTF response and an optical zoom.

Each of rows in FIG. 15 illustrates, in order from the lowest row, a state of capturing an image by an optical zoom 2.5 times lens of the optical lens with F-number 4.0, the cut-out area size from the imaging surface of the imaging device 32 with 1/2.3-type total number of pixels 18 mega, resize processing from the imaging area to the output size by image thinning interpolation, VGA-size image output, a display example by the image display section, and a microscopic subject image of one translucent living body of the image display section, respectively.

Also, each column in FIG. 15 illustrates, from left to right, the case of capturing an image using all the 18-M size area of the imaging surface of the imaging device 32, the case of capturing an image using a 4.9-M size area, and the case of using the VGA size in order to output a VGA-size image.

In the case of capturing an image using all the 18-M size, and outputting a VGA-size image by the resize processing, an imaging surface with a one-horizontal side of 4968 pixels is used. One pixel set unit having a 18-M size on the imaging surface, which corresponds to one pixel of the VGA-size image output, becomes an 8 H×8 V pixel set unit having eight pixels on one side (4968/640), and a pixel set unit having one side of 10.8 microns, which is eight times one pixel having a 1.26-micron length. This value is sufficiently greater than a pixel pitch (5 microns) necessary for the MTF response 0.7 by the optical zoom of the lens, and thus a determination is made that the MTF response of 0.7 or more is ensured.

In the case of capturing an image using from an 18-M pixel size to a 4.9-M pixel area, and outputting a VGA-size image by the resize processing, an imaging surface with a one-horizontal side of 2560 pixels is used. One pixel set unit having a 4.9-M size on the imaging surface, which corresponds to one pixel of the VGA-size image output, becomes a 4 H×4 V pixel set unit having four pixels on one side (2560/640), and a pixel set unit having one side of 5.04 microns, which is four times one pixel having a 1.26-micron length. This value is substantially equal to a pixel pitch (5 microns) necessary for the MTF response 0.7 by the optical zoom of the lens, and thus a determination is made that the MTF response of 0.7 or more is ensured by the 4.9-M pixel area on the imaging device surface.

In the case of capturing an image using a VGA-size pixel area from an 18-M pixel size, and outputting a VGA-size image, an imaging surface with a one-horizontal side of 640 pixels is used. One pixel set unit having a VGA size on the imaging surface, which corresponds to one pixel of the VGA-size image output, becomes a 1 H×1 V pixel set unit having one pixel on one side, and a pixel set unit having one side of 1.26 microns, which is one pixel of an 18-M imaging device having a 1.26-micron length without change. This value is less than a pixel pitch of 5 microns, which is necessary for the MTF response 0.7 by the optical zoom of the lens, and thus a determination is made that the MTF response of 0.7 or more is not ensured by the cut-out from the VGA pixel area on the imaging device, thereby fading contrast. And, an image to be obtained might become an indistinct image so that individual components of the subject becomes difficult to determine.

That is to say, at the time of capturing an image of a translucent subject, in the case of ensuring an MTF response of 0.7 or more of the optical lens of the cut-out zoom, a 4.9-M pixel area becomes the lower limit of the cut-out size by a cut-out zoom. The zoom magnification is defined by a ratio of the number of horizontal pixels, and thus the zoom magnification limit of the cut-out zoom that is allowed to maintain the MTF response 0.7 becomes the number of pixels of one horizontal side of the 18-M pixels (4968 pixels)/the number of pixels of one horizontal side of the 4.9-M pixels (2560 pixels)=about 2 times.

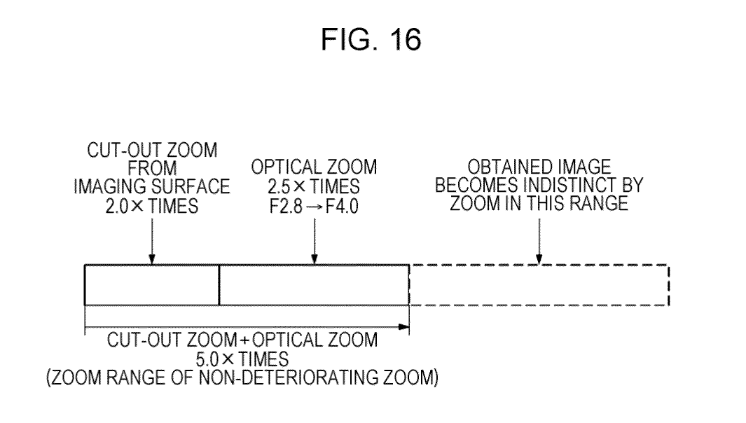

FIG. 16 schematically illustrates control of a non-deteriorating zoom by using an optical zoom and a cut-out zoom in combination. As described above so far, in an imaging apparatus on which an 18-M and 1/2.3-type imaging device including pixels of 1.26 microns is mounted, and on which an optical lens of an inner zoom method, in which an F-drop occurs from F2.8 to F4.0 by an optical zoom (zoom magnification 2.5 times) is mounted, in order to capture an image of a minute subject of a translucent living body by a pixel non-deteriorating zoom using a microscope adapter, it is necessary to perform zoom control suitable for the microscope adapter imaging mode.

Capturing an image with a contrast of 0.7 or more is possible in a range having a zoom control limit including the cut-out zoom 2.0 times, which is a limit without a contrast drop in a pixel set unit, and the optical zoom 2.5 times, which remains to have an F-drop to F-number 4.0 by an optical lens. The magnification exceeding this range by the optical zoom and the cut-out zoom makes it difficult to capture an image of a minute subject of a translucent living body having scarce contrast in the same manner as seen with the naked eye from the lens exit pupil of the eyepiece section of the microscope adapter, and a blurred image is obtained. That is to say, in the example, in the microscope adapter imaging mode of capturing an image of a translucent subject, a zoom range is set up to the zoom magnification 5 times that of the non-deteriorating zoom using the optical zoom (2.5 times) and the cut-out zoom (2 times) in combination. In the case where the microscope adapter imaging mode is set, this zoom range is displayed on the monitor 38, for example. It is possible to apply the contents described in an embodiment to the other processing in the example.

### 2. Variations

In the above, the description has been specifically given of an embodiment of the present disclosure. However, the present disclosure is not limited to the above-described embodiment, and various variations are possible on the basis of the technical idea of the present disclosure.

The setting of the microscope adapter imaging mode is not limited to through a user interface. For example, a slope of the imaging apparatus when placed on an acrylic plate, and so on may be detected by an acceleration sensor or a gyro sensor, and the microscope adapter mode may be automatically set in accordance with a detection result. Also, the imaging apparatus and the microscope adapter may perform near field communication, and the microscope adapter imaging mode may be automatically set through authentication by communication, and the like.

An imaging apparatus according to the present disclosure may be included in a mobile phone, a smart phone, a tablet-type computer, and the like.

Further, the present disclosure is not limited to an apparatus, and is possible to be achieved as a method, a program, or a recording medium on which a program is recorded.

In this regard, it is possible to suitably combine the configuration and the processing in the embodiment and the variations in a range in which no technical contradiction arises. It is possible to suitably change each of the processing sequences in the exemplified processing flows in a range in which no technical contradiction arises.

It is possible to apply the present disclosure to so-called cloud computing in which the exemplified processing is distributed by a plurality of apparatuses. It is possible to achieve the present disclosure as a system for performing the processing exemplified in the embodiment and the variations, and as an apparatus for performing at least a part of the exemplified processing.

It is possible to configure the present disclosure as follows.

(1) A control device including:
a detection section configured to detect setting to a predetermined imaging mode; and
a control section configured to set a predetermined method of zooming in response to the setting to the imaging mode, and to perform zoom control with a subject distance fixed.

(2) The control device according to (1),
wherein a non-deteriorating zoom is set as the predetermined method of zooming.

(3) The control device according to (2),
wherein the non-deteriorating zoom is a zoom by at least one of an optical zoom and a cut-out zoom.

(4) The control device according to any one of (1) to (3),
wherein the control section is configured to perform the zoom control so as to come to a focus at the subject distance fixed.

(5) The control device according to (4),
wherein the control section is configured to perform drive control of a plurality of lenses in an optical system so as to come to a focus at the subject distance fixed.

(6) The control device according to (4) or (5),
wherein the control section is configured to set a magnification factor of the zoom control.

(7) The control device according to (6),
wherein the control section is configured to set the magnification factor to not less than a magnification factor causing a periphery of an image obtained through a predetermined device to be excluded from a shooting angle of view.

(8) The control device according to any one of (1) to (7),
wherein the subject distance is fixed to a distance corresponding to a distance of distinct vision.

(9) The control device according to (8),
wherein the distance corresponding to the distance of distinct vision is 25 centimeters.

(10) The control device according to any one of (1) to (9),
wherein the imaging mode is an imaging mode using a microscope adapter.

(11) A method of controlling in a control device, the method including:
detecting setting to a predetermined imaging mode; and
setting a predetermined method of zooming in response to the setting to the imaging mode, and
performing zoom control with a subject distance fixed.

(12) An imaging apparatus including:
an imaging section;
a detection section configured to detect setting to a predetermined imaging mode; and
a control section configured to set a predetermined method of zooming in response to the setting to the imaging mode, and to perform zoom control with a subject distance fixed.

(13) The imaging apparatus according to (12), further including
an auxiliary light section for closeup imaging,
wherein light emission of the auxiliary light section for closeup imaging is prohibited in response to setting of the imaging mode.

(14) The imaging apparatus according to (12) or (13), further including
an auxiliary light section for auto focus,
wherein the light emission of the auxiliary light section for auto focus is prohibited in response to the setting to the imaging mode.

What is claimed is:

1. A control device comprising:
a detection section configured to detect setting to a predetermined imaging mode; and
a control section configured to set a predetermined method of zooming in response to the setting to the imaging mode, and to perform zoom control with a subject distance fixed.

2. The control device according to claim 1,
wherein a non-deteriorating zoom is set as the predetermined method of zooming.

3. The control device according to claim 2,
wherein the non-deteriorating zoom is a zoom by at least one of an optical zoom and a cut-out zoom.

4. The control device according to claim 1,
wherein the control section is configured to perform the zoom control so as to come to a focus at the subject distance fixed.

5. The control device according to claim 4,
wherein the control section is configured to perform drive control of a plurality of lenses in an optical system so as to come to a focus at the subject distance fixed.

6. The control device according to claim 4,
wherein the control section is configured to set a magnification factor of the zoom control.

7. The control device according to claim 6,
wherein the control section is configured to set the magnification factor to not less than a magnification factor causing a periphery of an image obtained through a predetermined device to be excluded from a shooting angle of view.

8. The control device according to claim 1,
wherein the subject distance is fixed to a distance corresponding to a distance of distinct vision.

9. The control device according to claim 8,
wherein the distance corresponding to the distance of distinct vision is 25 centimeters.

10. The control device according to claim 1,
wherein the imaging mode is an imaging mode using a microscope adapter.

11. A method of controlling in a control device, the method comprising:
detecting setting to a predetermined imaging mode; and
setting a predetermined method of zooming in response to the setting to the imaging mode, and
performing zoom control with a subject distance fixed.

12. An imaging apparatus comprising:
an imaging section;
a detection section configured to detect setting to a predetermined imaging mode; and
a control section configured to set a predetermined method of zooming in response to the setting to the imaging mode, and to perform zoom control with a subject distance fixed.

13. The imaging apparatus according to claim 12, further comprising
an auxiliary light section for closeup imaging,
wherein light emission of the auxiliary light section for closeup imaging is prohibited in response to setting of the imaging mode.

14. The imaging apparatus according to claim 12, further comprising
an auxiliary light section for auto focus,
wherein the light emission of the auxiliary light section for auto focus is prohibited in response to the setting to the imaging mode.
